(19) United States
(12) Patent Application Publication
(10) Pub. No.: US 2016/0158648 A1
(43) Pub. Date: Jun. 9, 2016

(54) AUTOMATED SELECTIVE SCORING OF USER-GENERATED CONTENT

(71) Applicant: Disney Enterprises, Inc., Burbank, CA (US)

(72) Inventor: Chris ADAMSON, Kelowna (CA)

(73) Assignee: Disney Enterprises, Inc.

(21) Appl. No.: 14/562,492

(22) Filed: Dec. 5, 2014

(51) Int. Cl. A63F 13/46; A63F 13/79; A63F 13/825

(52) U.S. Cl. CPC A63F 13/46; A63F 13/825; A63F 13/79

(57) ABSTRACT

Systems and methods for scoring user-generated content of a virtual space are presented herein. The user-generated content may be submitted for competition. One or more implementations of the systems and/or methods presented herein may facilitate conducting the competitions among users by automatically assigning scores once the user-generated content has been entered for consideration in a competition.

### FIELD OF THE DISCLOSURE

This disclosure relates to systems and methods for automatically scoring user-generated content of a virtual space.

### BACKGROUND

Users may access virtual spaces via computing platforms. Users may participate in the virtual space by creating user-generated content.

### SUMMARY

One or more aspects of the disclosure relate to a system for facilitating competition among users of a virtual space. One or more implementations of the system presented herein may provide a technique in which user-generated content submitted by users for entry into a competition may be instantly evaluated and assigned a score. High scoring user-generated content may then be presented to a provider of the virtual space, moderator of the competition, and/or other human entity associated with the virtual space to determine a winner, while low scoring user-generated content may be automatically discarded, and/or other considerations. This may not only reduce the amount of time required by human participants to review the submissions, but may improve the efficiency by which the processor(s) included in the computing system handling the submissions. For example, the scoring may be based on information that describes attributes of the user-generated content such that retrieval of the information that defines the user-generated content (e.g., source code) may not be needed until rendering of user-generated content for presentation to a moderator may be desired. Since presentation may be effectuated until the submission have been reduced down to only high scoring content, the processing loads associated with retrieving the user-generated content, rendering the user-generated content, and/or otherwise handling the user-generated content may be reduced.

The system may include one or more processors configured to execute one or more computer program components. The computer program components may include one or more of a space component, a user-generated content component, a submission component, a metadata component, a scoring component, a recommendation component, and/or other components.

The space component may be configured to execute an instance of a virtual space. The space component may be configured to implement the instance of the virtual space to facilitate user participation in the virtual space. Users may participate in the virtual space by submitting user-generated content for consideration in a competition. The submission of the user-generated content may be accompanied by submission of information that defines one or more attributes of the user-generated content.

The user-generated content component may be configured to receive entry and/or selection from the users for requests to define user-generated content within the virtual space. Entry and/or selection may be facilitated through one or more input mechanisms included with and/or coupled to the computing platforms. The users may provide entry and/or selection that correspond to requests related to selection, placement, and/or arrangement of one or more virtual objects and/or other content within the virtual space.

The submission component may be configured to identify user-generated content entered for consideration in a competition. The competition may be associated with judging criteria. The judging criteria may provide a basis through which expression of the user-generated content within a virtual space may be judged.

The metadata component may be configured to obtain the information that describes one or more attributes of the user-generated content. The attributes may include one or more of an aspect of a process through which the user-generated content was defined, a statistic that characterizes the user-generated content, user information associated with the user-generated content, and/or other information.

The scoring component may be configured to automatically assign scores to the user-generated content based on the obtained information. The scores may reflect the relative standings of the user-generated content within the competition with respect to the judging criteria and/or other criteria.

The recommendation component may be configured to effectuate presentation of a user interface including a recommendation of one or more winners of the competition. The user interface may be provided to a provider of the virtual space, moderator of the competition, and/or other entity associated with the virtual space. The recommendation may be presented as a user interface that illustrates the relative standings of the user-generated content, identifies the users associated therewith, and/or displays the scores assigned to the user-generated content. In some implementations, the relative standings may be used to determine the winner of the competition, and/or other considerations. In some implementations, the provider, moderator, and/or other entity may then edit the rankings and/or determine a winner by visually evaluating the top-scoring user-generated content, and/or other considerations.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates an implementation of a system for facilitating competition among users of a virtual space by scoring user-generated content of the virtual space.

FIG. 2 illustrates an implementation of a server employed in the system of FIG. 1.

FIG. 3 illustrates an implementation of a user interface for defining judging criteria of a user-generated content-based competition.

FIG. 4 illustrates an implementation of a user interface for presenting recommendations for one or more winners of a competition based on the assigned scores.

FIG. 5 illustrates an implementation of a method of facilitating competition among users of a virtual space.

### DETAILED DESCRIPTION

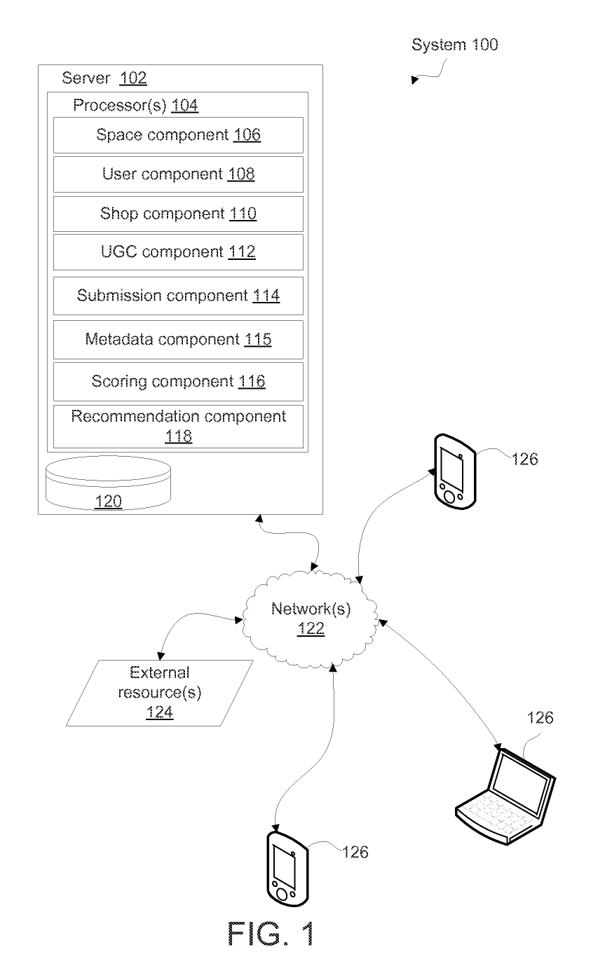

FIG. 1 illustrates a system 100 for facilitating competition among users of a virtual space. The competition may be associated with judging criteria that provide a basis through which expression of user-generated content within a virtual space may be judged. The user-generated content may be created by users of the virtual space via requests to define the user-generated content. The requests may be associated with entry and/or selection of virtual space content by users. The user-entered and/or—selected virtual space content may be expressed within the virtual space as user-generated content. Users may submit their user-generated content to the competition. One or more implementations of the system described herein facilitate automatic scoring and/or ranking of the user-generated content submissions. The scores and/or ranks may reflect relative standings of the user-generated content within the competition with respect to the judging criteria. The scores and/or ranks may facilitate determining at least one winner. In some implementations, the scoring and/or ranking of the user-generated content may be performed absent a competition taking place.

Users may access the virtual space through computing platforms 126 associated with the users. The computing platforms 126 may include, for example, a cellular telephone, a smartphone, a laptop, a tablet computer, a desktop computer, a television set-top box, smart TV, a gaming console, a client device, and/or other device suitable for the intended purpose(s) presented herein, and/or other considerations. In some implementations, the computing platforms 126 may be any device capable of network communications. In some implementations, the computing platforms 126 may include Internet-connected devices.

Herein, the term “content” may refer to virtual objects that may be expressed within the virtual space, and/or other considerations. Virtual objects may include virtual items and/or virtual goods that may be usable within the virtual space and/or otherwise may be expressed within the virtual space. Virtual items and/or goods may include one or more of a structure (e.g., a building, a house, a cave, an igloo, and/or other considerations), clothing (e.g., shirt, hat, pants, etc.), a furnishing (e.g., a chair, a table, a cabinet, a carpet, a picture, a wall covering, an appliance such as a stove, refrigerator, and/or other considerations), a decoration, an accessory, a pet, a virtual resource, a structural element, a vehicle, a food, a currency, a reward, a bonus, health, a potion, an enhancement, a mount, a power-up, a speed-up, and/or other considerations.

In some implementations, virtual objects and/or a collection of virtual objects may be associated with a common theme. A theme may be based on one or more of a brand (e.g., a real-world brand and/or virtual space brand), a color, a holiday, a movie, a real-world entity (e.g., a person, a place, and/or other considerations), a fantasy character (e.g., cartoon character, a game entity, a virtual space entity, and/or other considerations), a user-defined theme, and/or other considerations.

In some implementations, user participation in the virtual space may include controlling one or more game entities within the virtual space. A game entity may be one or more virtual objects that represent a user within the virtual space. Game entities may include one or more of a virtual character, group of characters, a virtual object, a battalion, a clan, a unit, a village, an army, and/or other considerations.

In FIG. 1, in some implementations, providing the virtual space may include hosting the virtual space over a network 122, such as the Internet. A host server 102 may include one or more processors 104 configured to execute one or more computer components for implementing an instance of a virtual space to facilitate user participation in the virtual space.

The computer program components may include one or more of a space component 106, a user component 108, a shop component 110, a user-generated content (UGC) component 112, a submission component 114, a metadata component 115, a scoring component 116, a recommendation component 118, and/or other components. The server 102 may be configured to communicate with one or more computing platforms 126 according to client/server architecture, and/or other considerations. The users may access system 100 and/or the virtual space via the computing platforms 126.

In some implementations, some or all of the functionality of the server 102 may be attributed to the computing platforms 126. In such implementations, providing the virtual space may include hosting the virtual space locally at the computing platforms. The computing platforms 126 may include one or more processors configured to execute the one or more computer components for implementing an instance of the virtual space and to facilitate the participation of one or more users in the virtual space and/or the video game. The computing platforms 126 may be configured to execute the instance of the virtual space using information stored by and/or local to the computing platforms (e.g., a game cartridge, game disk, memory card/stick, USB memory stick, electronic storage, and/or other considerations), and/or other information.

With that being said, the space component 106 may be configured to implement an instance of the virtual space executed by the computer components to determine state of the virtual space. The state may then be communicated (e.g., via streaming visual data, object/position data, and/or other state information) from server 102 to computing platforms 126 for presentation to users. The state determined and transmitted to a given computing platform 126 may correspond to a view for a user's character (or other game entity) being controlled by a user via input devices (e.g., a controller) at the given computing platform 126. The state determined and presented to a given computing platform 126 may correspond to a location in the virtual space (e.g., location in the game). The view described by the state for the given computing platform 126 may correspond, for example, to the location from which the view is taken, the location the view depicts, and/or other locations, a zoom ratio, a dimensionality of objects, a point-of-view, and/or parameters of the view. One or more of the view parameters may be selectable by the users.

An instance of the virtual space may comprise a simulated space that is accessible by users via clients (e.g., computing platforms 126) that present the views of the virtual space to a user. The simulated space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space and/or surface features of a surface or objects that are “native” to the space. In some instances, the topography may describe a surface (e.g., a ground surface) that runs through at least a substantial portion of the space. In some instances, the topography may describe a volume with one or more bodies positioned therein (e.g., a simulation of gravity-deprived space with one or more celestial bodies positioned therein). An instance executed by the computer components may be synchronous, asynchronous, and/or semi-synchronous.

The above description of the manner in which the state of the virtual space is determined by space component 106 is not intended to be limiting. The space component 106 may be configured to express the virtual space in a more limited, or richer, manner. For example, views determined for the virtual space representing the state of the instance of the virtual space may be selected from a limited set of graphics depicting an event in a given place within the virtual space. The views may include additional content (e.g., text, audio, pre-stored video content, and/or other content) that describes particulars of the current state of the place, beyond the relatively generic graphics. For example, a view may include a generic battle graphic with a textual description of the opponents to be confronted. Other expressions of individual places within the virtual space are contemplated.

Within the instance(s) of the virtual space executed by space component 106, users may control game entities, simulated physical phenomena (e.g., wind, rain, earthquakes, and/or other phenomena), and/or other elements within the virtual space to interact with the virtual space and/or each other. The game entities may include virtual characters such as avatars. As used herein, the term game entity may refer to any virtual objects present in the virtual space that represents an individual user. A game entity may be controlled by the user with which it is associated. The user-controlled element(s) may move through and interact with the virtual space (e.g., non-user characters in the virtual space and/or other objects in the virtual space). The user-controlled elements controlled by and/or associated with a given user may be created and/or customized by the given user. The user may have an “inventory” of virtual items and/or currency that the user can use (e.g., by manipulation of a game entity or other user-controlled element, and/or other items) within the virtual space.

The users may participate in the instance of the virtual space by controlling one or more of the available user-controlled game entities in the virtual space. Control may be exercised through control inputs and/or commands input by the users through computing platforms 126. The users may interact with each other through communications exchanged within the virtual space. Such communications may include one or more of textual chat, instant messages, private messages, voice communications, and/or other communications. Communications may be received and entered by the users via their respective computing platforms 126. Communications may be routed to and from the appropriate users through server 102 (e.g., through space component 106) and/or through communications which are external to the system 100 (e.g., text messaging services associated with the computing platforms 126).

In some implementations, the users may participate in an instance of the virtual space through entry and/or selection of virtual space content via the computing platforms 126. The entry and/or selection of virtual space content may generate and/or otherwise correspond to requests to define the virtual space content (e.g., user-generated content) within the virtual space (see, e.g., user-generated content component 112). For example, the users may provide entry and/or selection of virtual space content corresponding to requests to define customized virtual spaces, portion(s) of a virtual space, and/or other considerations. The user-generated content may include, for example, a game, a scene, an environment, one or more virtual objects, and/or other content.

In some implementations, the users may participate in an instance of the virtual space by viewing and/or sharing user-generated content with each other. Users may view instances of other users' user-generated content. The users may vote on which user-generated content they like. The users may vote on which user-generated content they dislike. For example, votes may include entry and/or selection of a “like,” “dislike,” “up-vote,” “down-vote,” and/or other considerations. The users may interact with other users' user-generated content in other ways. In some implementations, voting may take place during a user-generated content-based competition, prior to the competition, and/or at other times during participation in the virtual space.

In some implementations, the users may participate in an instance of the virtual space through gameplay events that take place in the virtual space. A gameplay event may include one or more of a multiplayer tournament, competition, game, mini-game, and/or other considerations. In some implementations, a competition may be associated with user submissions of user-generated content. The competition may be a user-generated content-based competition. The users may be judged based on judging criteria associated with the competition and/or other information. In some implementations, the judging criteria may be obtained from a provider, administrator, moderator, and/or any other entities related to the virtual space and/or competition (e.g., via user interface and/or other considerations). In some implementations, the competition may be facilitated by one or more components presented herein, including, but not limited to, the user-generated content component 112, the submission component 114, the metadata component 115, the scoring component 116, the recommendation component 118, and/or other components.

The instance of the virtual space and/or the online game that takes place therein may be persistent. That is, the virtual space and/or the game may continue on whether or not individual players are currently logged in and/or participating in the game. A player who logs out of the virtual space and then logs back in some time later may find the virtual space has been changed through the interactions of other players with the virtual space during the time the player was logged out. These changes may include changes to the simulated physical space, changes in the player's inventory, changes in other players' inventories, changes experienced by non-player characters, changes to the virtual items available for use in the online game, and/or other changes.

The user component 108 may be configured to access and/or manage one or more user profiles, user information, and/or user accounts associated with the users. The one or more user profiles and/or user information may include information stored locally to a given computing platform 126 by server 102, one or more other computing platforms, and/or other storage locations. The user profiles may include, for example, information identifying users (e.g., a username or handle, a number, an identifier, and/or other identifying information) within the virtual space, security login information (e.g., a login code or password), virtual space account information, subscription information, virtual (or real) currency account information (e.g., related to currency held in credit for a user), control input information (e.g., a history of control inputs provided by the user), reputation information, user-generated content history information, user-generated content-sharing history information, virtual inventory information (e.g., virtual inventories associated with the users that include one or more virtual items available for the users in the virtual space and/or game entities available to the user for use in a group of game entities in the virtual space), relationship information (e.g., information related to relationships between users in the virtual space), virtual space usage information (e.g., a login history indicating the frequency and/or amount of times the user logs in to the user accounts), demographic information associated with users, interaction history among users in the virtual space, information stated by users, browsing history of users, a computing platform identification associated with a user, a phone number associated with a user, and/or other information related to users.

The shop component 110 may be configured to present offers to sell instances of virtual items to users in a virtual shop. The virtual shop may be a simulated environment within the virtual space which is accessible by users and presents the views of the virtual shop to the users. Users may access the virtual shop through one of a variety of ways. Users may access the virtual shop through the manipulation of one or more entities associated with the user within the virtual space using control inputs and/or commands input by the users through client computing platforms 126, and/or other ways of access.

Manipulation of a game entity may include moving the game entity through the virtual space using control inputs and/or commands input by the users through client computing platforms 126 to move the one or more entities to the simulated environment designating the location of the virtual shop within the virtual space.

Users may use control inputs and/or commands not associated with a game entity to access the virtual shop. Control inputs and/or commands may automatically present the instance of the virtual shop on the client computing platforms 126 (e.g., user selects a virtual shop button to automatically be taken to the virtual shop).

The instance of the virtual shop may be presented to users through a shop interface. The shop interface may be configured to present the offers to sell virtual items to users. The shop interface may be configured to receive entry and/or selection of individual offers by the users to effectuate acceptance and/or purchase of the offers at a virtual (or real) currency purchase price.

The simulated environment of the virtual shop may have topography. The virtual shop may express ongoing real-time interaction by one or more users (e.g., may have limited stock of virtual items for sale which can be purchased by one or more users within the virtual space and which can be depleted), and/or include one or more objects (e.g., one or more virtual items, a virtual teller, and/or other objects) positioned within the topography that may be capable of locomotion within the topography. The virtual shop may display the virtual items and/or the one or more sets of virtual content available for purchase by the users. Users may view the virtual items (e.g., individual virtual items and/or sets of virtual items) available for purchase. Users may purchase the virtual items using virtual (or real) currency. Transactions may take place with the virtual teller, through various other actions of the user within the instance of the virtual shop, and/or other offer/transaction mechanisms. In some implementations, the shop component 110 may be configured to manage transfer of instances of virtual items to user inventories in response to purchase of the virtual items.

The user-generated content component 112 may be configured to facilitate the creation of user-generated content by the users of the virtual space. The user-generated content component may be configured to receive entry and/or selection from the users of virtual space content to be expressed within the virtual space. The user-generated content component 112 may be configured such that the entry and/or selection from the users of virtual space content generates and/or corresponds to requests to define user-generated content within the virtual space. The user-generated content may be expressed within the virtual space and experienced by users. Entry and/or selection may be facilitated through one or more input mechanisms included and/or coupled to the computing platforms 126.

In some implementations, receiving entry and/or selection for virtual space content may be facilitated via a user interface effectuated by the user-generated content component 112. For example, user-generated content component 112 may be configured to effectuate presentation of a user interface depicting a “blank” virtual space and/or portion of a virtual space. Users may make selections of virtual space content to customize the virtual space. User selections and/or entry of virtual space content for generating requests may be facilitated in a variety of ways. For example, the displayed user interface may include a pop-up window, drop down menu, drag-and-drop icons, lists, check boxes, and/or other techniques to facilitate content selection by the users. The users may be able to provide entry and/or selection for the content that corresponds to requests for selection, placement, and/or arrangement of one or more virtual objects and/or other content within the virtual space.

In some implementations, a “blank” virtual space may comprise a virtual space template and/or canvas. Virtual space templates and/or canvases may correspond to instances of the virtual space which include at least one virtual object and/or other content arranged in a predetermined position, arrangement, and/or other considerations. For example, a virtual space template and/or canvas may depict a “base” structure (e.g., a house, a cave, an igloo, and/or other considerations), a scene (e.g., a beach, a yard, a forest, and/or other considerations), and/or other content. The users may create user-generated content by “decorating” the template and/or canvas within the virtual space.

In some implementations, user-generated content may be associated with virtual objects which may be arranged and/or displayed within views of the virtual space in accordance with entry and/or selection by the users requesting such arrangement and/or display. Virtual objects may include one or more of structural building elements (e.g., a brick, a stone, a pillar, and/or other considerations), combinations of virtual objects that are arranged together to define a larger-scale virtual object (e.g., a virtual building made up of virtual building blocks, and/or other considerations), vehicles, characters, furnishings, pets, resources, decorations, accessories, appliances, wall coverings, non-player characters, and/or other considerations.

In some implementations, the user-generated content may be associated with metadata. The user-generated content component 112 may be configured to measure, track, collect, and/or otherwise manage metadata associated with the user-generated content. The metadata may include information that describes one or more attributes of the user-generated content, and/or other information. The attributes of the user-generated content may include one or more of an aspect of a process through which the user-generated content was defined, a statistic that characterizes the user-generated content, user information associated with the user-generated content, a name given to the content by the user, a description of the content, audio associated with the user-generated content (e.g., a user-selected song to accompany the user-generated content), and/or other information. The user-generated content component 112 may be configured to store and/or manage the metadata. The user-generated content 112 may be configured to provide access to the metadata by other components of the server 102. For example, the user-generated content component 112 may be configured to provide access to the metadata associated with user-generated content by the metadata component 115 and/or other components.

An aspect of a process through which the user-generated content was defined may include an amount of time spent by the user to create the user-generated content (e.g., “decorating time”). The user-generated content component 112 may be configured to measure and/or track the amount of time a user spends creating the user-generated content. The time spent creating the user-generated content may reflect the time spent while logged in to their virtual space account, time spent specifically interacting with the canvas and/or user-generated content, an amount of time from when the user started creating the user-generated content to when the user-generated content is submitted for competition, and/or other considerations.

A statistic that characterizes the user-generated content may be associated with one or more of an amount of coverage of the virtual space, template, and/or canvas, a symmetry of the selection and/or arrangement of the virtual objects included in the user-generated content, an amount of rare and/or valuable virtual objects included in the user-generated content, an amount of relatively older virtual objects included in the user-generated content, an amount of themed virtual objects, an amount of votes received in association with the user-generated content, an amount of visits by other users to view the user-generated content, and/or other considerations.

An amount of coverage of the virtual space may be associated with unit area of the virtual space, template, and/or canvas associated with the user-generated content. Unit area may be in terms of pixels, inches, millimeters, and/or other considerations. In some implementations, the virtual space, template, and/or canvas may be associated a given area. Individual ones of the virtual objects may be associated with a given area. The amount of coverage of the virtual space (e.g., percentage of coverage) may correspond to the total area of the virtual objects selected by the user, divided by the area of the virtual space, template, and/or canvas, and multiplied by 100. Amount of coverage may be considered in other ways.

Symmetry of the selection and/or arrangement of the virtual objects included in the user-generated content may be associated with a form, design, balance, pattern, and/or other metric associated with one or more virtual objects included in the user-generated content. In some implementations, individual ones of the virtual objects used in the creation of user-generated content may be rotated, mirrored, and/or duplicated. Users may position the virtual objects in a manner to create a symmetric pattern, a collage, a mosaic, and/or an array of the virtual objects within views the virtual space, and/or other considerations. A pattern may be defined by a balance of the virtual objects, an amount of duplicate and/or other combinations of virtual objects used, whether virtual objects are overlapping or evenly spaced, balance of colors of the virtual objects, textures of the virtual objects, and/or other considerations. The arrangement of the virtual objects may create a particular design and/or shape (e.g., a photo mosaic, a tessellation, a geometric shape, and/or other considerations). In some implementations, a pattern may be determined and/or detected by performing optical character recognition (OCR) to review the user-generated content. By way of non-limiting example, an OCR conversion of the user-generated content may facilitate detecting and/or recognizing patterns or arrangements that may not be detectable (or easily detectable) merely by evaluating the virtual items that make up the content individually. Such detection techniques may be “fuzzy-logic” techniques for evaluating the user-generated content. Symmetry and/or arrangement of the virtual objects within the user-generated content may be considered in other ways.

In some implementations, a virtual object may be a “rare” virtual object. The rarity of a virtual object may be reflected by the distribution of the virtual object within the virtual space. For example, a given rare virtual object may be made available to users of the virtual space in a limited amount (e.g., a limited release), only at certain times (e.g., a holiday promotion, and/or other considerations), only to certain users, after completion of a (difficult) task, by chance, and/or other considerations. A value of a virtual object may be reflected by a price (e.g., by real or virtual currency) of the virtual object within the virtual shop. A value of a virtual object may be reflected by an amount of performance enhancement (e.g., power, speed, agility, attack ability, defense ability, and/or other considerations) the virtual object may provide to the user within the virtual space. By way of non-limiting illustration, a virtual object that provides a 10× power increase may be considered more valuable than a virtual object that provides a 2× power increase, and/or other considerations. Rarity and/or value may be considered in other ways.

An age of a virtual object may be associated with a time at which the user acquired the virtual object, and/or other considerations. By way of non-limiting example, a virtual object that was acquired (e.g., purchased and/or other considerations) by a user further in the past may be considered “older” than a virtual object that may have been acquired more recently.

User information associated with the user-generated content may reflect one or more qualities of the content-creating user. The user information may include any of the information managed by the user component, and/or other considerations. The user information may include one or more of an age of the user account, a play history and/or activity history, user reputation, membership status, and/or other considerations. The age of a user account may reflect an amount of time since the user created an account within the virtual space, and/or other considerations. The play and/or activity history may reflect the amount of time the user has spent logged into their virtual space account, an amount of gameplay events participated in by the user, an amount of gameplay events won by the user, and/or other considerations. In some implementations, play history may reflect whether or not a user has previously won a user-generated content based competition.

User reputation may reflect whether a user has a good or bad reputation, and/or other considerations. A user with a bad reputation may be a player who as has received negative ratings from other players, has been reported by other players due to their conduct in the virtual space, has been banned from the virtual space, has received warnings from a virtual space administrator, has used offensive language, inappropriate images, and/or has otherwise behaved negatively in any way. A user with a good reputation may be a player who as has received positive ratings from other players, has not been reported by other players, has not been banned from the virtual space, and/or has otherwise behaved with good will.

Membership status may reflect whether the user may be a premium service member (e.g., paid member and/or other considerations), a non-premium service member, and/or other considerations. In some implementations, a premium service member may have access to premium (e.g., high valued) virtual items or other content while a non-premium service member may not, and/or other considerations. User information may be considered in other ways.

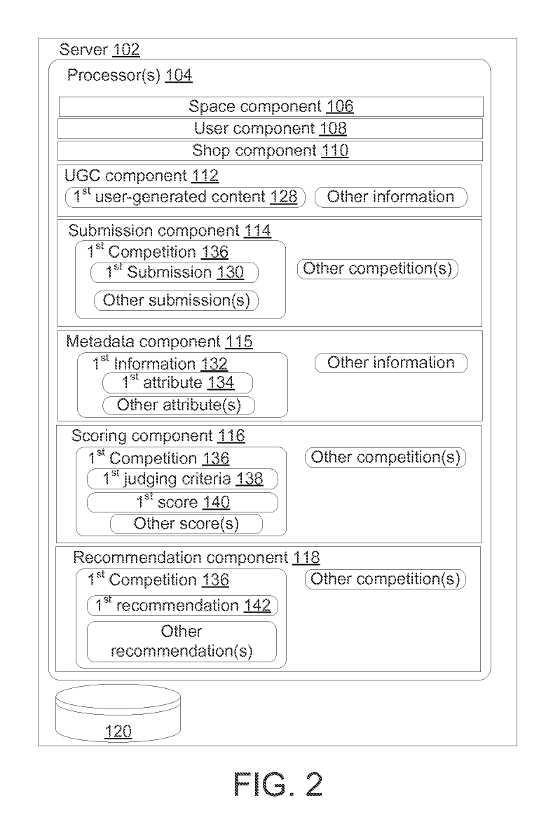

As an illustrative example in FIG. 2, the user-generated content component 112 may be configured to facilitate creation of first user-generated content 128 by a first user (not shown in FIG. 2). The first user-generated content 128 may be associated with information that defines the first user-generated content 128 (e.g., source code for the first user-generated content 128), metadata associated with the first user-generated content 128, and/or other information

Returning to FIG. 1, the submission component 114 may be configured to receive submissions of user-generated content for entry into a competition by the users. The submission component 114 may be configured to identify the user-generated content, the user who created the user-generated content, and/or other information.

In some implementations, the users may be notified of an upcoming user-generated content-based competition and/or other gameplay event. Notifications may include an in-game message and/or external message communicated to the users of the virtual space. The notification may indicate a deadline and/or time period in which users may submit their user-generated content. User submission may include submission of information that defines the user-generated content (e.g., source code), a description of the user-generated content, metadata associated with the user-generated content, and/or information. Once a user submits their user-generated content, the user may be restricted from further configuring their user-generated content, or may be given a final time period in which they may make any additional changes, additions, and/or modifications up until a winner is declared, and/or other considerations.

As an illustrative example in FIG. 2, the submission component 114 may be configured to receive a first submission 130. The first submission 130 may identify the first user-generated content 128 for submission in a first competition 136. The first submission 130 of the first user-generated content 128 may be accompanied by information that defines the first user-generated content 128 (e.g., source code for the first user-generated content 128), metadata associated with the first user-generated content 128, and/or other information.

The metadata component 115 may be configured to obtain information that describes one or more attributes of the user-generated content (e.g., metadata associated with the user-generated content). The metadata component 115 may obtain the information by virtue of user submission of the user-generated content for competition. For example, the metadata component 115 may obtain the information that describes the user-generated content from the submission component 114. In some implementations, the metadata component 115 may obtain the information from the user-generated content component 112, and/or other components.

In some implementations, the metadata component 115 may be configured to obtain the information independently from user submission of the user-generated content to a competition. By way of non-limiting example, users may request that the metadata associated with their user-generated content be obtained insofar as to receive a score associated with their user-generated content. In some implementations, the metadata component 115 may be configured to automatically obtain the information that describes one or more attributes of the user-generated content automatically (e.g., absent user request), and/or other considerations.

As an illustrative example in FIG. 2, the metadata component 115 may be configured to obtain first information 132. The first information 132 may be associated with the first user-generated content 128. The first information 132 may include metadata associated with the first user-generated content 128. The first information 132 may include information that describes a first attribute 134 and/or other attributes of the first user-generated content 128.

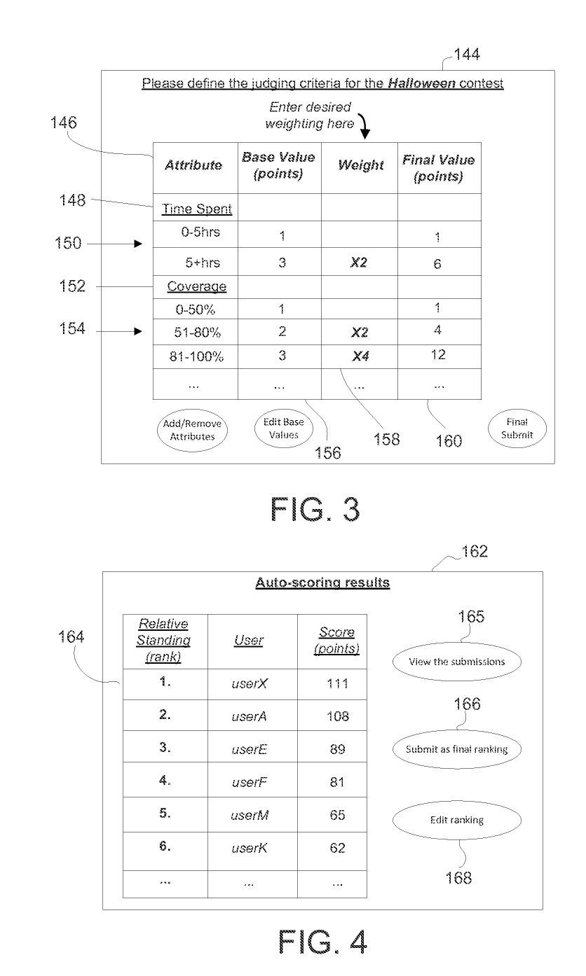

The scoring component 116 may be configured to obtain judging criteria associated with a competition. In some implementations, the scoring component 116 may obtain judging criteria from the provider, administrator, moderator, and/or any other entities related to the virtual space. For example, the provider(s) of the virtual space may provide judging criteria of interest to the provider(s) via a graphical user interface for each competition, and/or other considerations. An implementation of a user interface 144 facilitating input of judging criteria for a contest is depicted in FIG. 3 and described herein.

The judging criteria may describe how different attributes associated with the user-generated content may be considered, valued, and/or weighed for determining scores of the user-generated content and/or for ultimately for determining a winner of a competition, and/or other considerations. For example, the judging criteria may specify how one or more of an aspect of a process through which the user-generated content was defined, a statistic that characterizes the user-generated content, user information associated with the user-generated content, a name given to the content by the user, a description of the content, audio associated with the user-generated content, and/or other attribute of the user-generated content may be applied toward determining a score.

In some implementations, individual ones of the attributes and/or combinations of attributes may be associated with one or more values (e.g., points and/or other considerations). The judging criteria may specify weights to be applied to the values of individual ones of the attributes and/or combinations of attributes (see, e.g., user interface 144 in FIG. 3). For example, individual ones of the attributes and/or combinations of attributes may have one or more base values. The weights determined by the judging criteria may be applied to the base values and may increase or decrease the base value to a final value used for determining a score. The values (final values) of the attributes of the user-generated content may then be tallied for determining the score.

FIG. 3 illustrates an implementation of a user interface 144 for defining judging criteria 146. It is noted that FIG. 3 and the accompanying description are provided for illustrative purposes only and are not to be considered limiting. In other implementations, the attributes, quantity of attributes, values, and/or weights may be considered in other ways. For example, judging criteria 146 may be associated with more or fewer attributes than shown and may have different values and/or weights than those depicted and described herein.

In some implementations, individual ones of the attributes 148 and 152 may be defined by different attribute levels 150 and 154, respectively, at which different values may be assigned. For example, a first attribute may include at least one level at which a first value may be assigned. Referring to FIG. 3, the attributes shown include Time Spent 148 and Coverage 152. The Time Spent attribute 148 may include levels 150 that characterize different amounts of time a user may have spent creating the user-generated content including, but not limited to, 0 to 5 hours or more than 5 hours, and/or other considerations. The Coverage attribute 152 may include levels 154 that characterize different amounts of coverage of the virtual space, template, and/or canvas (e.g., percentage of coverage, and/or other considerations) including, but not limited to, 0 to 50%, 51 to 80%, 81 to 100%, and/or other considerations.

Although only two attributes and associated levels are currently shown, in some implementations, the user interface 144 may facilitate adding and/or removing attributes to be considered for the judging within a competition. For example, another attribute may include a Themed Virtual Objects attribute (not shown in FIG. 3), and/or other attribute. The Themed Virtual Objects attribute may include levels that characterize different amounts of virtual objects that meet the desired theme, including, but not limited to, 0 to 3 virtual objects, 4 to 7 virtual objects, 8 to 12 virtual objects, more than 13 virtual objects, and/or other considerations. Attributes and/or attribute levels may be considered in other ways.

In some implementations, each of the attributes and/or levels may be associated with a base value 156, and/or other considerations. The base values 156 may be values associated with the attributes and/or levels independent of competition. In some implementations, the base values 156 may or may not be editable by the provider and/or moderator who may be defining the judging criteria of a particular competition.

In some implementations, the user interface 144 may facilitate entry and/or selection by a user (e.g., provider, competition moderator, and/or other considerations) of weights 158 to be applied to the base values 156. The weights 158 may include, for example, value multiplier, a percentage applied toward the final score, and/or other considerations. Entry and/or selection may be facilitated by a text input field, drop down menu, scrolling menu, and/or other considerations. The weights may be entered and/or selected by a provider based on the given competition and, therefore, may vary between different competitions. By way of non-limiting example, in a given competition, the provider may wish to focus the judging criteria on different ones of the attributes associated with the user-generated content and, therefore, may provide more weight to those particular attributes. The weights may be applied to determine final values 160 of the different attributes. A score may be determined by tallying the final values for the attributes specified for consideration in the judging criteria of the competition.

Referring to FIG. 3, the judging criteria entered and/or selected via the user interface 144 may specify that user-generated content associated with users who spent more than 5 hours creating the user-generated content and/or covered 80 to 100 percent of the virtual space, template, and/or canvas may be valued higher than others. Again, the attributes, values, and weights shown in FIG. 3 are provided for illustrative purposes only and are not to be considered limiting. For example, alternatively or in addition to the implementation shown, base values may be associated with incremental levels of the attribute, as opposed to ranges, and/or other considerations. By way of non-limiting example, for the Time Spent attribute, a base value (e.g., 1 point) may be associated with each half hour (or other amount) spent creating the user-generated content, and/or other considerations. As such, a user who spent 4 hours creating user-generated content may be awarded 8 points for the Time Spent attribute, and/or other considerations. As another non-limiting example, for the Coverage attribute, a base value (e.g., 1 point) may be associated with each 10% of coverage (or other amount) of the virtual space, template, and/or canvas, and/or other considerations. As such, user-generated content that covers 30% of a canvas may be awarded 3 points for the Coverage attribute, and/or other considerations.

The scoring component 116 may be configured to automatically assign scores to the user-generated content based on the obtained information (e.g., describing the one or more attributes of the user-generated content) and the judging criteria, and/or other considerations. Once the information that describes the one or more attributes of the user-generated content is obtained, the one or more attributes may be correlated with their corresponding final values defined by the judging criteria. The scores may be determined by tallying the final values associated with the attributes of the user-generated content.

The automatically assigned scores may reflect relative standings of the users with respect to the judging criteria, and/or other considerations. The automatically assigned scores may be presented to a provider of the virtual space, moderator of the competition, and/or other human entity associated with the virtual space as a recommendation of one or more winners of the competition (e.g., via recommendation component 118).

The automatic scoring facilitated by the components of the system 100 presented herein may provide a technique in which user-generated content may be instantly evaluated as soon as the information that describes the one or more attributes of the user-generated content has been obtained. High scoring user-generated content may then be presented to a provider, moderator, and/or other entity to determine a winner, while low scoring user-generated content may be automatically discarded. This may not only reduce the amount of time required by human participants to review the submissions, but may improve the efficiency by which the processor(s) 104 handles the submissions. For example, since the scores may be assigned based on the information that describes the attributes of the user-generated content, the rendering of the user-generated content itself may not be needed until a human participant decides to review the top-scoring user-generated content at their discretion, if at all. That is, the information that defines the user-generated content (e.g., source code), which may require a considerable amount of processing power and/or functionality to maintain, store, and/or render the user-generated content, may be placed in a queue while the scoring is taking place. As such, in some implementations, the scoring may take place without a provider, moderator, and/or other human entity needing to view the user-generated content itself. Other advantages and improvements provided by the system may be apparent to those skilled in the art.

By way of non-limiting example of an implementation of the system 100, providers of the virtual space may specify the weights to be applied to individual ones of the attributes or combinations of attributes, given the context of a competition and/or for other reasons. A competition may be a themed competition (e.g., Halloween), and/or other considerations. A first attribute may be associated with the statistic that characterizes an amount of virtual objects that are of the particular theme. The first attribute of first user-generated content may specify that the first user-generated content included a first amount of virtual objects of the particular theme, and/or other considerations. A base value for having the first amount of themed virtual objects may be a first base value. A provider may specify that having a first amount of the themed virtual objects should be weighted twice the base value, and/or other considerations. The final value of the first attribute for the first user-generated content may be a first final value (e.g., twice the first base value), and/or other considerations. A first score assigned to the first user-generated content may be determined based on at least the first final value (e.g., the first final value added to any other final values of any other attributes specified in the judging criteria, if any).

As an illustrative example in FIG. 2, the scoring component 116 may be configured to automatically assign a first score 140 to the first user-generated content 128, and/or assign other scores to other user-generated content. The first score 140 may be automatically assigned in accordance with submission of the first user-generated content 128 to the first competition 136, and/or other considerations. The first score 140 may be determined based on the first attribute 134 and/or other attributes of the first user-generated content 128. The first attribute 134 may be associated with a first value (not shown). The first score 140 may be determined based on first judging criteria 138 associated with the first competition 136. The scoring component 116 may be configured to assign other scores to other user-generated content based on the same or other criteria.

Returning to FIG. 1, the recommendation component 118 may be configured to effectuate presentation of a recommendation of one or more winners of the competition. The recommendation may be in the form of a user interface that illustrates the final assigned scores of the user-generated content entered for the competition. The user interface may be presented at a computing platform associated with a provider of the virtual space, moderator of the competition, and/or other human entity associated with the virtual space. The final assigned scores may be provided in a user interface presented at a computing platform associated with the provider, moderator, and/or other entity. In some implementations, the provider, moderator, and/or other entity may determine the winner of the competition based on the assigned scores. For example, if two or more users are assigned a same or similar score, the provider, moderator, and/or other entity may visually inspect the user-generated content and ultimately determine the winner at their own discretion. However, in some implementations, the assigned scores may be submitted as the final ranking of the competition in which the user with the highest assigned score may be the winner.

As an illustrative example in FIG. 4, an implementation of an auto-scoring results user interface 162 is depicted. The user interface 162 may be presented at a computing platform associated with a provider, moderator, and/or other entity. As depicted, the user interface 162 may include a results portion 164. The results portion 164 may depict the relative standings of the users who submitted user-generated content for the competition based on the assigned scores (e.g., via scoring component 116). The results portion 164 may depict the relative rankings (e.g., 1^{st}, 2^{nd}, 3^{rd}, etc.), the usernames of the users who submitted user-generated content and their relative positions, the scores that were automatically assigned based on the judging criteria, and/or other information. The user interface 162 may be configured to provide interface elements 165, 166, and 168 that may allow the provider, moderator, and/or other entity to view the top ranked submissions, submit the auto-assigned scores as the final ranking, or edit the ranking at their own discretion, respectively, and/or carry out other tasks. If the provider, moderator, and/or other entity decide to edit the ranking, the provider, moderator, and/or other entity may be provided the option to view the submitted user-generated content (e.g., in a pop-up window, and/or other considerations) and make his or her final ranking judgment based on a visual evaluation of the user-generated content, and/or based on other criteria.

As an illustrative example in FIG. 2, the recommendation component 118 may be configured to effectuate presentation of a first recommendation 142 to the provider of the virtual space, moderator of the first competition 136, and/or other human entity associated with virtual space. The first recommendation 142 may be in the form of an auto-scoring results user interface (e.g., user interface 162 shown in FIG. 4) and/or other considerations. The first recommendation 142 may include a description of the final assigned scores of the user-generated content entered for the first competition 136. For example, the first recommendation 142 may include a relative standing of the first user based on the first score 140, and/or other considerations.

Returning to FIG. 1, server 102, computing platforms 126, and/or external resources 124 may be operatively linked via one or more electronic communication links. For example, such electronic communication links may be established, at least in part, via a network (e.g., network(s) 122) such as the Internet and/or other networks. It will be appreciated that this is not intended to be limiting, and that the scope of this disclosure includes implementations in which server 102, computing platforms 126, and/or external resources 124 may be operatively linked via some other communication media.

The external resources 124 may include sources of information that are outside of system 100, external entities participating with system 100, and/or other resources. In some implementations, some or all of the functionality attributed herein to external resources 124 may be provided by resources included in system 100.

Server 102 may include electronic storage 120, one or more processors 104, and/or other components. Server 102 may include communication lines or ports to enable the exchange of information with a network and/or other computing platforms. Illustration of server 102 in FIG. 1 is not intended to be limiting. The server 102 may include a plurality of hardware, software, and/or firmware components operating together to provide the functionality attributed herein to server 102. For example, server 102 may be implemented by a cloud of computing platforms operating together as server 102.

Electronic storage 120 may comprise electronic storage media that electronically stores information. The electronic storage media of the electronic storage may include one or both of storage that is provided integrally (i.e., substantially non-removable) with the respective device and/or removable storage that is removably connectable to the respective device. Removable storage may include, for example, a port or a drive. A port may include a USB port, a firewire port, and/or other port. A drive may include a disk drive and/or other drive. Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private network, and/or other virtual storage resources). Electronic storage may store files, software algorithms, information determined by processor(s), and/or other information that enables the respective devices to function as described herein.

Processor(s) 104 is configured to provide information-processing capabilities in the sever 102. As such, processors 104 may include one or more of a digital processor, an analog processor, a digital circuit designed to process information, an analog circuit designed to process information, a state machine, and/or other mechanisms for electronically processing information. Although the processor 104 is shown in FIG. 1 as a single entity within the server 102, this is for illustrative purposes only. In some implementations, the processors 104 may include one or more processing units. The processing units may be physically located within the same device, or may represent processing functionality of a plurality of devices operating in coordination.

For example, processor 104 may be configured to execute components 106, 108, 110, 112, 114, 115, 116, and/or 118. Processor 104 may be configured to execute components 106, 108, 110, 112, 114, 115, 116, and/or 118 by software; hardware; firmware; some combination of software, hardware, and/or firmware; and/or other mechanisms for configuring processing capabilities on processor 104.

It should be appreciated that, although components 106, 108, 110, 112, 114, 115, 116, and 118 are illustrated in FIG. 1 as being co-located within a single processing unit, in implementations in which processor 104 includes multiple processing units, one or more of components 106, 108, 110, 112, 114, 115, 116, and/or 118 may be located remotely from the other components. The description of the functionality provided by the different components 106, 108, 110, 112, 114, 115, 116, and 118 described above is for illustrative purposes, and is not intended to be limiting, as any of components 106, 108, 110, 112, 114, 115, 116, and/or 118 may provide more or less functionality than is described. For example, one or more of components 106, 108, 110, 112, 114, 115, 116, and/or 118 may be eliminated, and some or all of its functionality may be provided by other ones of components 106, 108, 110, 112, 114, 115, 116, 118, and/or other components. As another example, processor 104 may be configured to execute one or more additional components that may perform some or all of the functionality attributed to one or more of components 106, 108, 110, 112, 114, 115, 116, and/or 118.

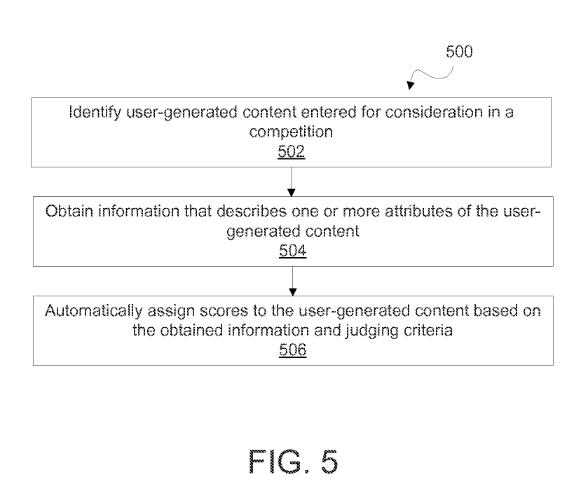

FIG. 5 illustrates an implementation of a method 500 of facilitating competition among users of a virtual space. The operations of method 500 presented below are intended to be illustrative. In some implementations, method 500 may be accomplished with one or more additional operations not described, and/or without one or more of the operations discussed. Additionally, the order in which the operations of method 500 are illustrated in FIG. 5 and described below is not intended to be limiting.

In some implementations, method 500 may be implemented in one or more processing devices (e.g., a computing platform, a digital processor, an analog processor, a digital circuit designed to process information, an analog circuit designed to process information, a state machine, and/or other mechanisms for electronically processing information), and/or one or more other components. The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

Referring now to method 500 in FIG. 5, at an operation 502, user-generated content entered for consideration in a competition may be identified. In some implementations, operation 502 may be performed by a submission component the same as or similar to submission component 114 (shown in FIG. 1 and described herein).

At an operation 504, information that describes one or more attributes of the user-generated content may be obtained. In some implementations, operation 504 may be performed by a metadata component the same as or similar to metadata component 115 (shown in FIG. 1 and described herein).

At an operation 506, scores may be automatically assigned to the user-generated content based on the obtained information and judging criteria. In some implementations, operation 506 may be performed by a scoring component the same as or similar to scoring component 116 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system for facilitating competition between users of a virtual space, the system comprising:
one or more physical processors configured by computer-readable instructions to:
identify user-generated content entered for consideration in a competition, the competition being associated with judging criteria that provide a basis through which expression of the user-generated content within a virtual space is judged, the identified user-generated content including first user-generated content;
obtain information that describes one or more attributes of the user-generated content, the attributes including one or more of an aspect of a process through which the user-generated content was defined, a statistic that characterizes the user-generated content, or user information associated with the user-generated content, the obtained information including first information that describes a first attribute of the first user-generated content; and
automatically assign scores to the user-generated content based on the obtained information, the scores reflecting relative standings of the user-generated content within the competition with respect to the judging criteria, the assigned scores including a first score that is automatically assigned to the first user-generated content based on the first information.

2. The system of claim 1, wherein the one or more physical processors are configured by computer-readable instructions, such that assigning scores comprises determining values associated with individual ones of the one or more attributes, and determining the scores based on the values, such that assigning the first score comprises determining a first value associated with the first attribute.

3. The system of claim 1, wherein the one or more physical processors are configured by computer-readable instructions such that the values associated with attributes are weighted values.

4. The system of claim 1, wherein the one or more physical processors are configured by computer-readable instructions to effectuate presentation of the assigned scores to a moderator of the competition, wherein the moderator determines the winner of the competition.

5. The system of claim 1, wherein the one or more physical processors are configured by computer-readable instructions such that the assigned scores determine the winner of the competition.

6. The system of claim 1, wherein the one or more physical processors are configured by computer-readable instructions such that the statistic that characterizes the user-generated content includes an amount of themed virtual objects included in the user-generated content.

7. The system of claim 1, wherein the one or more physical processors are configured by computer-readable instructions such that the statistic that characterizes the user-generated content includes an amount of coverage of the virtual space.

8. The system of claim 1, wherein the one or more physical processors are configured by computer-readable instructions such that the process through which the user-generated content was defined includes an amount of time spent by the user to create the user-generated content.

9. The system of claim 1, wherein the one or more physical processors are configured by computer-readable instructions such that the user information associated with the user-generated content includes an age of the user account of a user that created the user-generated content.

10. The system of claim 1, wherein the one or more physical processors are configured by computer-readable instructions such that the statistic that characterizes the user-generated content includes an amount of votes received in association with the user-generated content.

11. A method of facilitating competition between users of a virtual space, the method being implemented in a computer system including one or more physical processors and storage media storing machine-readable instructions, the method comprising:
identifying user-generated content entered for consideration in a competition, the competition being associated with judging criteria that provide a basis through which expression of the user-generated content within a virtual space is judged, the identified user-generated content including first user-generated content;
obtaining information that describes one or more attributes of the user-generated content, the attributes including one or more of an aspect of a process through which the user-generated content was defined, a statistic that characterizes the user-generated content, or user information associated with the user-generated content, the obtained information including first information that describes a first attribute of the first user-generated content; and
automatically assigning scores to the user-generated content based on the obtained information, the scores reflecting relative standings of the user-generated content within the competition with respect to the judging criteria, the assigned scores including a first score that is automatically assigned to the first user-generated content based on the first information.

12. The method of claim 11, wherein assigning scores comprises determining values associated with individual ones of the one or more attributes and determining the scores based on the values, such that assigning the first score comprises determining a first value associated with the first attribute.

13. The method of claim 11, wherein the values associated with attributes are weighted values.

14. The method of claim 11, additionally comprising effectuating presentation of the assigned scores to a moderator of the competition, wherein the moderator determines the winner of the competition.

15. The method of claim 11, wherein the assigned scores determine the winner of the competition.

16. The method of claim 11, wherein the statistic that characterizes the user-generated content includes an amount of themed virtual objects included in the user-generated content.

17. The method of claim 11, wherein the statistic that characterizes the user-generated content includes an amount of coverage of the virtual space.

18. The method of claim 11, wherein the process through which the user-generated content was defined includes an amount of time spent by the user to create the user-generated content.

19. The method of claim 11, wherein user information associated with the user-generated content includes an age of the user account of a user that created the user-generated content.

20. The method of claim 11, wherein the statistic that characterizes the user-generated content includes an amount of votes received in association with the user-generated content.
